(19) United States
(12) Patent Application Publication
(10) Pub. No.: US 2004/0203514 A1
(43) Pub. Date: Oct. 14, 2004

(54) Mobile phone with detachable covers

(76) Inventors: Yung-Fa Cheng, Taipei (TW); Kuo-Hsiang Wu, Taipei (TW); Hsiang-Lung Kao, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/272,108

(22) Filed: Oct. 16, 2002

(30) Foreign Application Priority Data
Jun. 21, 2002 (TW) 91209368

(51) Int. Cl. H04B 1/38; H04M 1/00

(52) U.S. Cl. 455/90.3; 455/348; 379/433.11; 455/550.1; 455/575.1

(57) ABSTRACT

A mobile phone with detachable covers. The phone body provided with a threaded hole, a cover detachably connected to the body defining a hole, and a connecting element having a threaded post twisted through the hole and into the threaded hole to fix the cover and the body together. The body and the cover are separable.

### BACKGROUND OF THE INVENTION

1. Field of the Invention

The present invention relates in general to a mobile phone with detachable covers. In particular, to a mobile phone including a cover removably secured thereto such that the cover is easily detachable and interchangeable with other covers to satisfy the demands of variety. Moreover, the present invention relates to a mobile phone including a body and a cover, fastened by a connecting element having a threaded post with easy detachability for easy engagement.

2. Description of the Prior Art

Currently, mobile phone technology has improved rapidly and the popularity thereof is expanding, such that mobile phone use is widespread. Models and colors are many and varied. Mobile phone design addresses not only communication service, user-friendly interface, light weight, and low consumption, but also diverse interchangeable covers to change the appearance of the mobile phone.

Presently, there are various types of mobile phones with detachable covers. FIG. 1A shows a conventional mobile phone (10) with a detachable cover, including a frame (13), a main circuit board (12), an upper cover (11) and a lower cover (14). The frame (13) is mainly metal or plastic to connect the print circuit board (PCB) (12) to the upper and lower covers (11, 14) or a battery (not shown in the figure). The upper and lower covers (11, 14) are usually plastic. The component used for changes in appearance is usually the upper cover (11). A plurality of hooks (110) is disposed on the interior side of the upper cover (11). On the frame (13), there is a first groove (130) corresponding to a first hook (110) of the upper cover (11). Furthermore, a plurality of elastic members (132) is disposed on the frame (13). When a user wants to assemble the cover and the body, the first hook (11) on the upper cover (11) must be aligned with the first groove (130) on the frame (13). Then, by applying external force, the first hook (110) and the first groove (130) are engaged. Finally, the first hook (110) is secured on the side of the first groove (130). By applying external force on the elastic member (132) disposed on the frame (13), the force bends the elastic member (132) and firmly connects to the lower cover (14) to complete assembly of the mobile phone. Also, when separating the covers from each other, applying external force on the elastic member (132) separates it from the lower cover. Then, the first hook (110) on the upper cover (11) and the first groove (130) on the frame (13) are separated to remove the covers from the mobile phone. FIG. 1B shows a local enlarged view of the first hook (110) disposed on the cover (11). The first hook (110) is plastic, so when external force is applied thereon, the force bends the first hook (110) elastically, and consequently, the first hook (11) slips into the first groove (130) to connect the upper cover (11) with the frame (13). Since the first hook (110) is manufactured with a predetermined slope, the first hook (110) can be easily removed from the frame when separating the covers.

The method mentioned above is most widely seen on mobile phones with interchangeable covers. However, plastic is the common material of the covers, which frequently cracks. Moreover, as shown in the above figure, it is necessary to carefully target the hook to the groove to engage them and the structures thereof are very small, making it difficult and also time-consuming to engage them. As well, even if the connection is not broken due to excessive external force, the elastic member may become fatigued due to changing (connection and separation) frequently, and thus, the hook or the groove may ultimately fragment. In some cases, if the mobile phone is dropped or jarred, the design of the hook and groove will not sustain the reaction forces and the components may separate or fracture. Thus, the covers cannot protect the PCB, the screen and other components. Furthermore, the covers are plastic, which, to withstand repeated use, must be manufactured with required thickness. Thus, the covers of the mobile phone cannot be thin and light.

Based on the above, the shortcomings of conventional changeable mobile phone covers are as follows: difficult engagement between hook and groove, low strength of hook and groove, and inconveniently thick covers.

### SUMMARY OF THE INVENTION

An object of the present invention is to provide a mobile phone with detachable covers without hook-groove structures. The thickness of the mobile phone covers is greatly reduced and also provides optimum strength to protect the body. Changing covers is easy and fast.

Another object of the present invention is to provide a mobil phone with detachable covers, including a body provided with a threaded hole, a cover defining a hole, and a connecting element having a threaded post. When engaging the body and the cover together, the connecting element having a threaded post is twisted through the hole and into the thread hole so that the cover and the body are firmly connected.

### BRIEF DESCRIPTION OF THE DRAWINGS

The present invention can be more fully understood by reading the subsequent detailed description in conjunction with the examples and references made to the accompanying deawings, wherein:

FIG. 1A is an exploded diagram of a conventional mobile phone;

FIG. 1B is a local enlarged view of FIG. 1A;

FIG. 2A is a perspective diagram of a mobile phone with detachable covers in accordance with a first embodiment of the present invention;

FIG. 2B is a perspective diagram of the mobile phone with detachable covers in accordance with the first embodiment of the present invention;

FIG. 3A is a sectional view of the mobile phone with detachable covers in accordance with a second embodiment of the present invention;

FIG. 3B is a sectional view of the mobile phone with detachable covers in accordance with the second embodiment of the present invention.

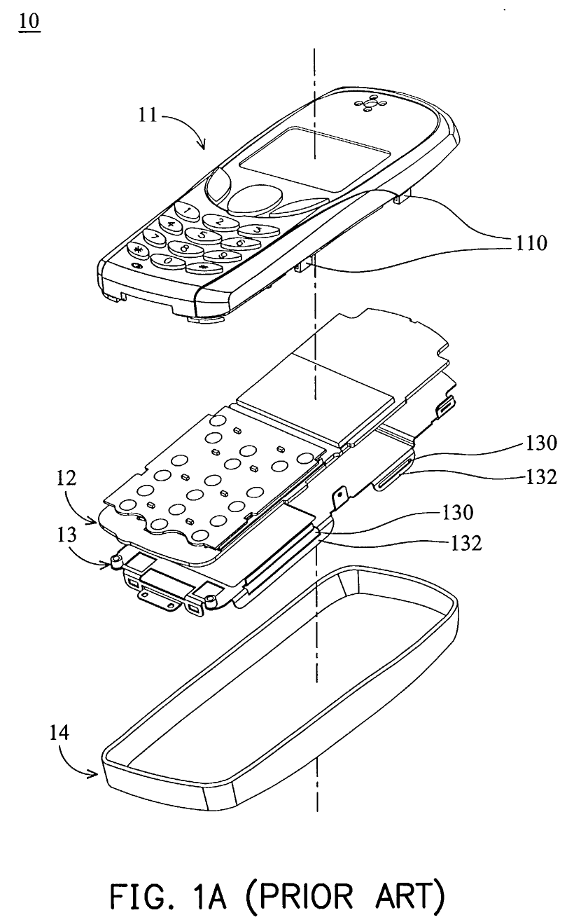

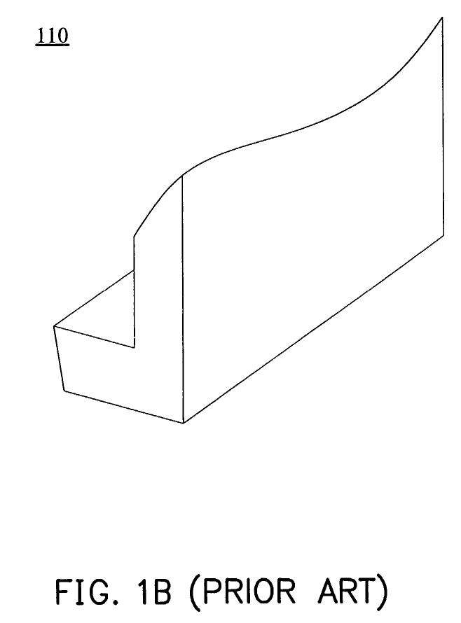

### DETAILED DESCRIPTION OF THE INVENTION

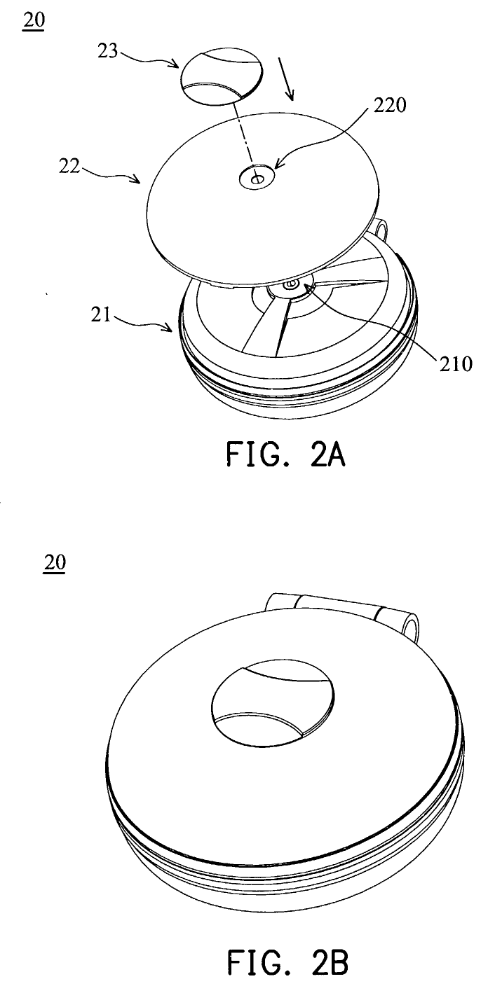

Referring to FIGS. 2A and 2B, a mobile phone with detachable covers in the present invention includes a body (21) provided with a threaded hole (210), a cover (22) defining a hole (220), and a connecting element (23) having a threaded post.

FIG. 2A shows a perspective view of the mobile phone in accordance with the present invention. The mobile phone with detachable covers, comprising the body (21) provided with the threaded hole (210), the cover (22) detachably connected to the body (21) defining the hole (220), and the connecting element (23) having the threaded post twisted through the hole (210) and into the threaded hole (220) to fix the cover and the body together. FIG. 2B shows a 3-dimensional view of the mobile phone after assembly.

The mobile phone with detachable covers (20) of the present invention utilizes a connecting element (23) having a threaded post, so the cover (22) can be any material, such as metal or plastic. Also, the cover (22) does not have the design of hooks or grooves; thus, thickness is greatly reduced, reducing the weight of the phone. Furthermore, the present invention utilizes the connecting element (23) having a threaded post to fasten the cover (22) to the body (21), providing a strong connection between the cover (22) and the body (21) without affecting the appearance of the mobile phone, further effectively protecting the body. Moreover, the present invention utilizes the connecting element (23) having a threaded post designed to provide convenient changing of covers without engaging a hook with a groove. The problem of broken engaging portions due to incorrect external force and the failure of the engaging portion due to fatigue are both avoided. Thus, the reliability of the present invention is greatly increased.

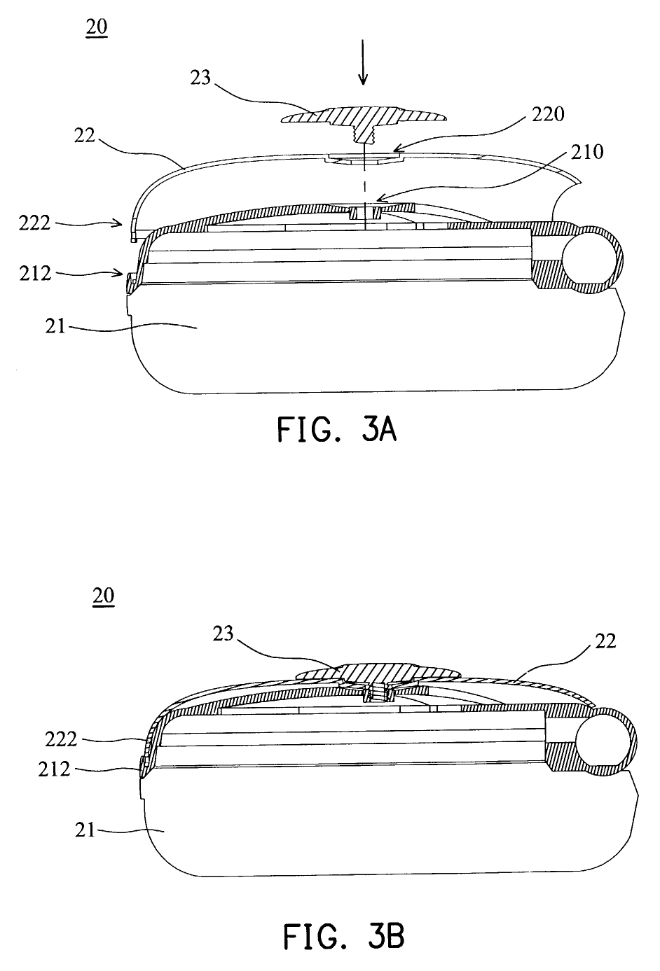

To describe the present invention more thoroughly, a second embodiment is disclosed herein. As shown in FIGS. 3A and 3B, a mobile phone with detachable covers in the second embodiment of the present invention includes a body (21) provided with a threaded hole (210), a cover (22) defining a hole (220), and a connecting element (23) having a threaded post. The cover (22) is moveably disposed on the body (21).

FIG. 3A is a sectional view of the mobile phone in accordance with the present invention. The mobile phone with detachable covers comprises the body (21) provided with the threaded hole (210), the cover (22) detachably connected to the body (21) defining the hole (220), and the connecting element (23) having a threaded post twisted through the hole (210) and into the threaded hole (220) to fix the cover and the body together. FIG. 3B shows a 3-dimensional view of the mobile phone after assembly.

Furthermore, the body (21) further comprises a first engaging portion (212), and the cover (22) further comprises a second engaging portion (222). When the cover (22) and the body (21) are engaged, the first engaging portion (212) and the second engaging portion (222) are engaged, the second engaging portion is fastened to the first engaging portion. As shown in FIG. 3A and FIG. 3B, the first engaging portion (212) is a groove, and the second engaging portion (222) is a flange.

Similarly, the first engaging portion (212) can be interchanged with the second engaging portion (222). Thus, the first engaging portion (212) becomes a flange. The second engaging portion (222) becomes a groove. The arrangement of the first engaging portion (212) and the second engaging portion (222) is optional.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A mobile phone with detachable covers, comprising:
a body provided with a threaded hole;
a cover, detachably connected to the body, defining a hole; and
a connecting element having a threaded post twisted through the hole and into the threaded hole to fix the cover and the body together.

2. A mobile phone with detachable covers as claimed in claim 1, wherein the body defining a groove and the cover including a flange, and the flange is detachably fitted into the groove.

3. A mobile phone with detachable covers as claimed in claim 1, wherein the body including a flange and the cover defining a groove, and the flange is detachably fitted into the groove.

4. A mobile phone with detachable covers, comprising:
a body provided with a threaded hole, including a first engaging portion;
a cover, detachably connected to the body, defining a hole, including a second engaging portion; and
a connecting element having a threaded post,
wherein the threaded post twisted through the hole and into the threaded hole to fix the cover and the body together, the second engaging portion is fastened to the first engaging portion.

5. A mobile phone with detachable covers as claimed in claim 4, wherein the body defining a groove and the cover including a flange, and the flange is detachably fitted into the groove.

6. A mobile phone with detachable covers as claimed in claim 4, wherein the body including a flange and the cover defining a groove, and the flange is detachably fitted into the groove.
